(19) United States
(12) Patent Application Publication
(10) Pub. No.: US 2020/0218599 A1
(43) Pub. Date: Jul. 9, 2020

(54) METHODS AND SYSTEMS FOR SMART MEMORY DATA INTEGRITY CHECKING

(71) Applicant: Hewlett Packard Enterprise Development LP, Houston, TX (US)

(72) Inventors: ROBERT C. ELLIOTT, Houston, TX (US); MARK S. FLETCHER, Houston, TX (US); ROBERT VOLENTINE, Houston, TX (US)

(21) Appl. No.: 16/243,534

(22) Filed: Jan. 9, 2019

(51) Int. Cl. G06F 11/10; G06F 3/06

(52) U.S. Cl. CPC G06F 11/1004; G06F 3/0619; G06F 9/4401; G06F 3/0679; G06F 3/0659

(57) ABSTRACT

Systems and methods provided for verifying the data integrity of a persistent memory device, may include: initiating a boot for a system including the persistent memory device; and determining whether a data integrity check setting is enabled for the boot. Furthermore, upon determining that a smart data integrity check condition is satisfied, a data integrity check for the persistent memory device can be executed. The data integrity check can include scanning data stored in the memory locations associated with the persistent memory device to detect whether at least one uncorrectable memory error is present within the persistent memory device. In the event at least one uncorrectable memory error is detected, writing each detected uncorrectable memory error to a memory error log, and communicated the memory error log to the Operating System (OS) of the system.

### DESCRIPTION OF RELATED ART

As the demand for high performance and optimization increases in many computing applications (e.g. databases, analytics), there are advantages in utilizing computer systems that make data available as quickly and reliably as possible. Accordingly, there is also a desire for computer storage technology to progressively move towards even faster access to critical and frequently used data. However, in many traditional computer systems, there exists a performance gap between main system processors (typically having higher performance) and embedded processors of storage devices (typically having lower performance). Factors that may contribute to this disparity can include CPU frequency and register widths (e.g., server processors having 64 bits, in comparison to embedded processors having 32 bit instruction sets). The progression of storage technology has evolved in both aspects of accessing data and storing data to address these constraints. The progress has led to an emergence of a trend in storage technology away from magnetic storage and towards solid state media, where storage functionality can be implemented on the memory bus. Thus, emerging storage devices can take advantage of the interconnect's low latency and fast performance. Persistent memory is a developing category of non-volatile memory, which can reside on the memory bus of a server, for example. Accordingly, persistent memory technology combines the performance of standard memory, but with the added persistence of traditional storage. Even further, persistent memory can provide additional advantages, such as implementing byte-addressable storage, a semantic that can cut through cumbersome software layers and achieve sub-microsecond device latencies.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example of a high-performance system including multiple servers having persistent memory devices installed therein and implementing smart memory data integrity checking techniques, according to some embodiments.

FIG. 2 illustrates an example of a persistent memory device shown in FIG. 1 and scanned using smart memory data integrity checking techniques, according to some embodiments.

FIG. 3 is a block diagram depicting an example of a persistent memory device shown in FIG. 1 and the components therein, according to some embodiments.

FIG. 4 is an operational flow diagram illustrating an example of a process for executing smart memory data integrity checking techniques, according to some embodiments.

FIG. 5 illustrates an example computer system that may be used in implementing various smart memory data integrity checking features relating to the embodiments of the disclosed technology.

The figures are not exhaustive and do not limit the present disclosure to the precise form disclosed.

### DETAILED DESCRIPTION

Various embodiments described herein are directed to verifying the integrity of data stored in persistent memory devices, which realize advanced memory error detection and recovery. For purposes of discussion, the various systems and techniques of the disclosed embodiments may be referred to herein as smart memory data integrity checking (SMDIC). Trends in computer systems, such as server utilization, cloud computing, and high-performance computing may lead to increasing demands on the requirements for server memory. For example, many resource-intensive applications require increased speed, capacity, and availability of the system's memory devices. Moreover, constraints associated with memory can impact other attributes of the system, such as the system's reliability, performance, and overall power consumption. Utilizing persistent memory devices can deliver the performance of memory combined with the persistence of storage. The integration achieved with persistent memory devices can optimize the system's memory capabilities and functions for these abovementioned high-performance applications. Additionally, disclosed SMDIC systems and techniques can provide advanced memory error detection and recovery for persistent memory devices, thereby enhancing their reliability, verifying the integrity of the data accessed and/or stored therein, and enhancing the overall protection of the system.

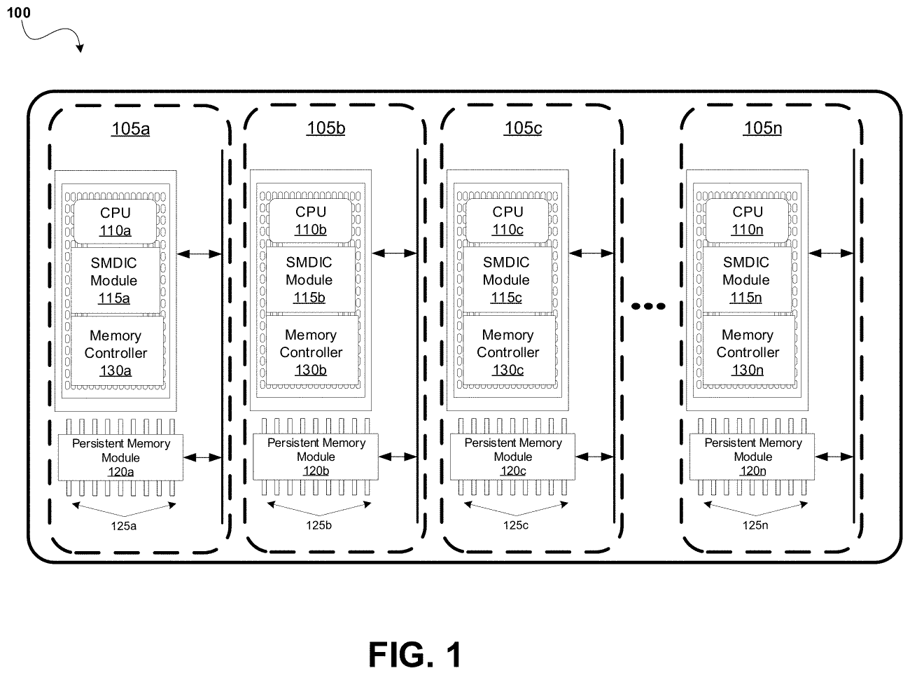

FIG. 1 depicts an example of a high-performance system 100 including multiple servers 105a-105n having multiple persistent memory devices 125a-125n installed therein, respectively. High-performance system 100 can employ a modular hardware configuration, including multiple servers 105a-105n to accommodate for performance demands in many computing applications. In the example, the servers 105a-105n are illustrated as rack servers that may be interconnected to form system 100 for increased processing and high performance. According to the embodiments, each of the servers 105a-105n include the capabilities relating to smart memory data integrity checking (SMDIC) techniques. For purposes of discussion, the disclosed SMDIC techniques are particularly discussed pertaining to a single server, namely server 105a. Each of the remaining servers 105b-105n can implement all of the SMDIC techniques in a manner similar to that discussed in reference to server 105a. It should be appreciated that although system 100 is shown to include servers 105a-105n, the number of servers included in the system 100 is intended to be configurable as deemed necessary and/or appropriate based on the operational conditions, such as scaling to diverse workloads and applications, or adapting to space-constrained environments (e.g., on-site rack enclosure). As an example, system 100 may be a used by a high-performance data center running diverse workloads across traditional and multi-cloud environments. For purposes of illustration, SMDIC aspects are described in reference to FIG. 1 as a function of persistent memory. However, it should be appreciated that SMDIC techniques may be generally implemented for various other memory or storage devices that are accessible by a computer device, such as random-access memory (RAM), read-only memory (ROM), erasable programmable read-only memory (EPROM), hard drives, network attached storage (NAS), and the like.

FIG. 1 shows a portion of the architecture for each of the servers 105a-105n. As seen, the servers 105a-105n each have multiple internal components that can function in concert to implement the server's capabilities, such as processing and the disclosed SMDIC techniques. For example, servers 105a include central processing unit (CPU) 110a, SMDIC module 115a, slots 120a for persistent memory devices 125a, and memory controller 130a. In some cases, the CPU 110a may be designed as a processor allowing for enhanced compute having faster processing and high-speed memory access. Although only CPU 110a is illustrated, the server 110a can include multiple CPUs, or processor cores, in a scalable manner to be optimized for a desired operational specification, such as increased workload performance. The memory controller 130a is illustrated as a component of the CPU 110a. The memory controller 130 can be implemented as logic to communicate with a memory bus in order to control access to persistent memory devices 125 installed therein. For purposes of brevity, each of the servers 105b-105n include all of the elements and also function in a manner similar to that discussed in reference to server 105a in FIG. 1, and therefore the other servers 105b-10n in system 100 are not discussed in detail again.

As shown in FIG. 1, server 105a includes slots 120a for inserting the persistent memory devices 125a into, allowing the server 105a to have the combination of a high-speed memory capacity with added persistence, as alluded to above. The slots 120a for persistent memory devices 125a can be openings, or receptacles, capable of receiving a plurality of individual persistent memory devices 125a. In some cases, the slots 120a can be a memory slot, which can also be used to install standard memory modules. However, it should be appreciated that persistent memory devices 125 differ from standard system memory, in that the persistent memory devices 125a can be used as a faster storage for another tier of storage, or as persistent main memory for applications that can benefit from its use (e.g., in-memory databases), for example. Persistent memory devices 125a are primarily used as a faster tier of storage in the server 105a, such as in the cases of application acceleration and caching. Additionally, an Operating System (OS) of the server 105a can access persistent memory devices 125a as a block storage device, in a manner similar to applications accessing traditional storage devices such as hard disk drives (HDDs) and solid-state drives (SSDs). In some implementations, persistent memory devices 125a are designed to provide increased data performance and reduced latencies. As an example, persistent memory devices 125a may have nanosecond latencies (approximately) compared to latencies in the hundreds of microseconds for other conventional fast storage devices, such as accelerators. It should be appreciated that some persistent memory devices may perform at the same speed (or slower) than conventional memory devices.

In the example of FIG. 1, slots 120a are depicted as having nine persistent memory devices 125 inserted therein. However, it should be appreciated that the slots 120a can be designed for expandability. For example, the slots 120a can include openings for installing up to 24 persistent memory devices 125a. Future generations of servers are likely to support larger numbers of persistent memory devices. Additionally, some existing systems, such as eight socket systems, can support more persistent memory devices than the abovementioned example of 24 persistent memory devices. Thus, as the slots 120a includes multiple openings, it allows for installing a scalable number of persistent memory devices 125a (e.g., up to 12) as deemed necessary within server 105a.

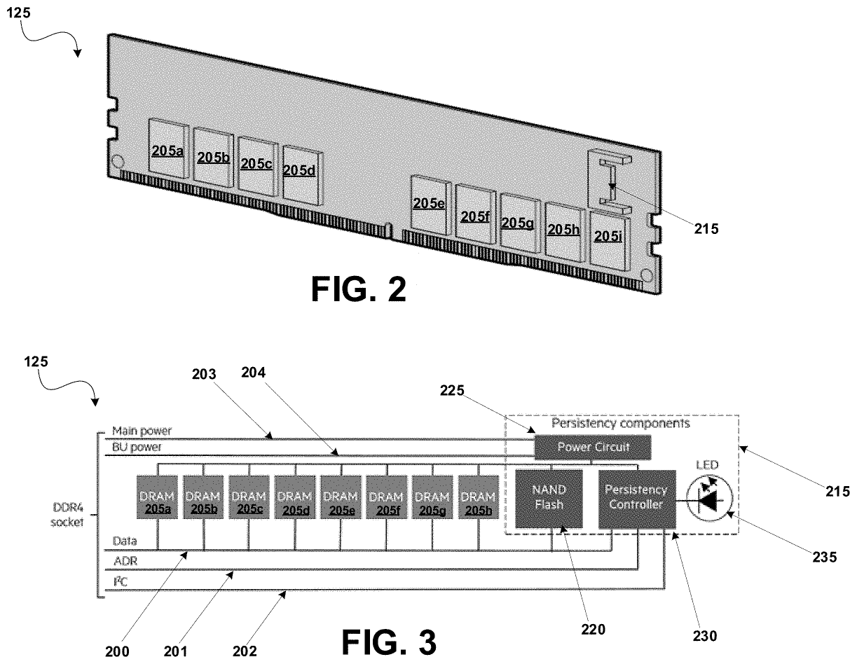

In some embodiments, persistent memory devices 125a are implemented as non-volatile dual in-line memory module (NVDIMM). FIG. 2 shows a more prominent view of a persistent memory device 125, which is a NVDIMM board (e.g., printed circuit board) in the example. Referring now to FIG. 2, the persistent memory device 125a can generally be described as a board including volatile dynamic random-access memory (DRAM) based system memory, shown as DRAM chips 205a-205i to achieve the high-performance. Additionally, the persistent memory device 125 includes NAND flash-based persistency components 215 to implement power-off storage persistency, as alluded to above. As an example, a NVDIMM board can combine substantially matching memory sizes for DRAM and flash (e.g., 8 GB of DRAM and 8 GB of flash). It should be appreciated that there are other embodiments of persistent memory devices that can include slower storage class memory (SCM). Often times, these persistent memory devices include a controller, slower storage media, and their media is persistent rather than volatile. The fact that the controller can include a slow embedded controller is pertinent to the overall speed and performance of executing conventional memory error detection mechanisms, as mentioned in the disclosure. Furthermore, the SMDIC techniques disclosed herein can also be implemented in other types of NVDIMMs and memory devices that do not include dedicated DRAM and flash-based regions.

FIG. 3 illustrates an example architecture of a persistent memory device 125 in an NVDIMM implementation. The illustrated example in FIG. 3 is intended to show a type of NVDIMM, namely non-volatile dual in-line memory module with NAND flash (NVDIMM-N). Furthermore, the SMDIC techniques disclosed herein are not limited to the example environment of NVDIMM-Ns but extend to other types of NVDIMMs. Additionally, memory devices that use non-volatile memory (NVM) as its main memory (such as Apache Pass) can employ the SMDIC techniques described. Referring to FIG. 3, the architecture fully integrates the DRAM chips 205a-205h with the persistency components 215 within a single module. In general, DIMMs, such as NVDIMM-N, can be configured to include several DRAM chips (e.g., nine chips). In some cases, different non-volatile memory chips can be employed in lieu of (or in addition to) DRAM chips. As seen in FIG. 3, the persistency components include NAND flash chip 220, persistency controller 240 (having a light emitted diode 235), and power circuit 225. In the embodiments, the persistent memory device 125 offers both a byte-addressable and block storage interface. Furthermore, the persistent memory device 125 uses the NAND flash chip 220 in backup operations. For example, of the persistent aspects regarding NVDIMM-N, in the event of a power down, the power circuit 225 can maintain power on the persistent memory device 125 (receiving backup power from a storage battery via BU power line 204) so data residing on DRAM chips 205a-205h can be moved to NAND flash chip 220.

During normal operation, the persistency controller 240 may continuously monitor the I²C bus 202 and the ADR signal 201 for a notification of events that may threaten the data stored in DRAM chips 205a-205h. Examples of these data threatening events include but are not limited to: sudden power loss; shutdown/restart initiated from the OS; catastrophic system errors; and operating system errors. Notification of a data threatening events can result in the persistency controller 240 initiating a backup operation. Subsequent to triggering a backup operation, the persistency controller 240 can systematically transfer all of the contents within volatile DRAM chips 205a-205h onto the onboard NAND flash chip 220.

According to the embodiments, the persistent memory device 125 can also perform restore operations, which can be generally described as the reverse of the abovementioned backup operation. For example, as the system boots, the persistency controller 240 transfers the contents of the NAND flash chip 220 back to the DRAM chips 205a-205h. The persistent memory device 125 is configured to perform advanced memory error detection including the disclosed SMDIC techniques. In some cases, error detection is performed as a result of the restore operation, where the persistent memory device 125 is scanned by the host CPU 110a for any errors that may have occurred during the backup operation, as many unintended power-off events (e.g., operating system crashes) can comprised the integrity of the data stored in the DRAM chips 205a-205h. In other cases, NVMs (as opposed to NVDIMM-Ns) can encounter uncorrectable memory errors, although not necessarily due to the same causes as uncorrectable memory errors in NVDIMM-Ns alluded to above. Nevertheless, the presence of uncorrectable memory errors can have similarly negative impacts on NVMs. As an example, in the event of a severe system crash (e.g., CPU internal error) system firmware may be unable to store data in a metadata storage area, so any previously encountered bad addresses may not be maintained. Thus, after such a system crash, NVMs should scan for uncorrectable memory errors. Moreover, other scenarios may lead to uncorrectable memory errors in NVMs, including but not limited to: development of errors during transit; presence of newly added NVMs; and machine check exceptions. Accordingly, SMDIC techniques can be applied to NVMs.

Referring back to FIG. 1, the server 105a can include a SMDIC module 115a which implements the abovementioned memory scanning, and various additional features of the advanced memory error detection. Uncorrectable memory errors can cause applications and an OS to crash, which can negatively impact the system 100 by causing unplanned downtime, requiring repairs, and degrading performance. In some cases, an entire memory module may need to be replaced due to presence of uncorrectable memory errors. As disclosed herein, the term “uncorrectable” means a memory error that is typically associated with multiple bits within a memory location that may be critical, sometimes non-recoverable, and may further lead to a system shutdown. Conventional memory error detection mechanisms, such as simple error event counters, may not be effective or efficient in large scale systems (e.g., containing up to 14 trillion memory transistors). The SMDIC aspects disclosed provide improved techniques that can more fully capture uncorrectable memory errors, provided attempted recovery of uncorrectable memory errors, and optimize data integrity checks (also referred to herein as memory scans) to run in instances where there is a predicted increased probability for compromised module health, thereby improving efficiency of the process.

In FIG. 1, the SMDIC module 115a is illustrated as being executed by the CPU 110a. According to this embodiment, the processing capabilities of the server's 105a main processor, namely CPU 115a (e.g., 28 cores and 3.6 GHz processing), can be leveraged to execute the techniques of the SMDIC module 115a. Consequently, the embodiment illustrated in FIG. 1 can realize a significant reduction in execution time and improved performance of the SMDIC techniques over conventional memory error detection mechanisms. Some existing memory error detection mechanisms may use a processing resource on the memory module itself, having limited capabilities as compared to a main processor. In many instances, the restrictions associated with these processing resources further impose restrictions on the capabilities of its memory error detection. Conventional memory error detection mechanisms may only support a limited number of errors that can be logged and/or detected (e.g., partial error list), including only up to 10 or 16 errors, for example. Also, these existing memory error detection mechanisms that general run on slower embedded processors, may require approximately an hour to complete a scan of 12 GB of memory. In contrast, the SMDIC module 115a executing on a main processor can potentially reduce the time needed to scan a persistent memory device of a similar size down to approximately one minute. However, it should be appreciated that the disclosed advanced memory error detection techniques are not confined to the aforementioned embodiment, and the functions of the SMDIC module 115a can be implemented in any other processing resource included in, or accessible to, the server 105a as deemed appropriate.

The SMDIC module 115a can be configured to detect specific conditions that may cause memory performance degradation or may significantly increase the probability of an uncorrectable memory error being present in one or the persistent memory devices 125. For purposes of discussion, features related to predicting an uncorrectable memory error event (which may signify a non-recoverable memory error) can be described as the “smart” aspects of the disclosed SMDIC techniques disclosed herein. For example, the SMDIC module 115a determines whether an error log associated with a previous boot includes a previously detected uncorrectable memory error. Logs can be any record or list that includes events, failures, errors, and information that can be generated by the system, such as, system error logs, logs maintained in the memory module, and the like. In the case when an uncorrectable memory error was detected during a memory scan from the previous boot, the condition indicates that the server 105a may be more susceptible to the same uncorrectable memory error, or additional uncorrectable memory errors. Thus, the SMDIC module 115a can determine that the presence of the previous uncorrectable memory error constitutes a smart data integrity check condition, or a prediction of an uncorrectable memory error event. The smart data integrity check condition can then trigger a memory scan of persistent memory devices 125a for the detection of current errors. As a result, the SMDIC module 115a will detect an uncorrectable memory error in the event that it persists even after a warm reset, or a cold reset of the server 105a. This improves the disclosed SMDIC techniques over some existing memory error detection mechanisms that only log the uncorrectable memory error (without recovery or scrubbing), leaving the system vulnerable to crash repeatedly from encountering the same uncorrectable memory error during boot (or the same uncorrectable error on subsequent boots). In some cases, the system boot operation does not complete until both the restore operation described above, including all of the memory error detection functions of the SMDIC module 115a, are complete. Consequently, reducing the amount of time dedicated to performing integrity checks by the SMDIC module 115a, in turn, reduces the amount of time that elapses during a boot operation, or in other words increases server 105 uptime.

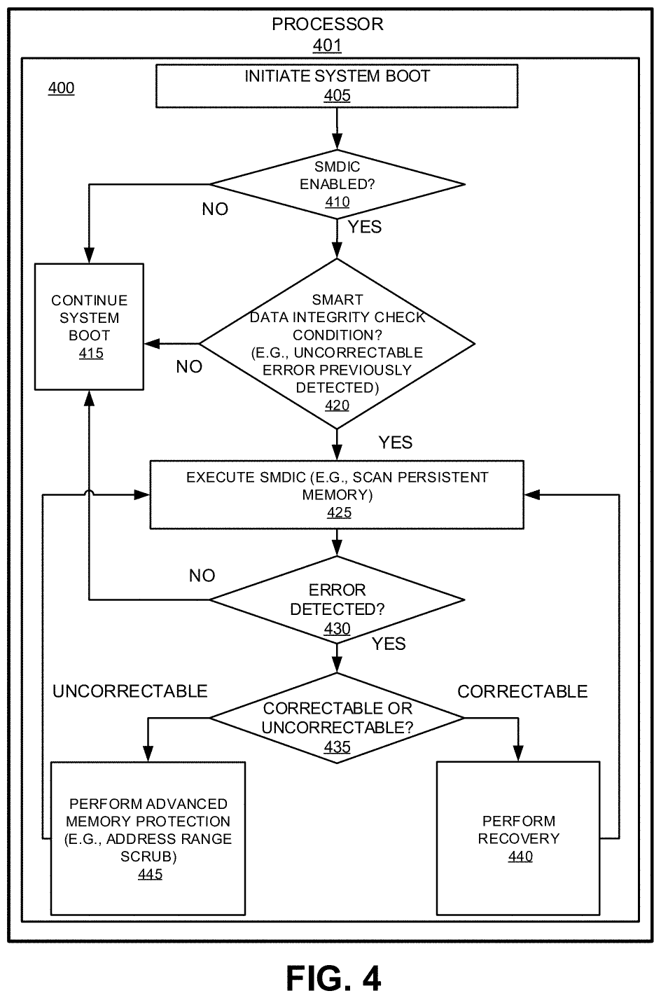

Additionally, the SMDIC module 115a can implement customization of the advanced memory error detection techniques, including the “smart” data integrity checking implemented by SMDIC 115a. In some implementations, the SMDIC module 115a is configured to use one of multiple modes of advanced memory error detection. In a “smart” mode, the SMDIC module 115a is configured to run memory scans in the event of a predicted uncorrectable memory error condition, as described in greater detail above. In another mode, the SMDIC module 115a can be configured to always perform a memory scan. For instance, at every boot or after every restoration operation, the SMDIC module 115a performs a full memory scan of all of the persistent memory devices 125a. In yet another mode, the SMDIC module 115a can be configured to not run a memory scan of the persistent memory devices 125a in almost all cases. According to this embodiment, the SMDIC module 115a does not perform a memory scan even if the smart data integrity check feature is enabled (or disabled) for the persistent memory device 125 at installation. The aforementioned modes of the SMDIC module 115a may be implemented as a Basic Input/Output System (BIOS) setting, or a setting in other non-volatile firmware of server 105a. Additional advanced memory protection features may be implemented by the SMDIC module 115a, discussed in greater detail with reference to FIG. 4. In an embodiment, the SMDIC module 115a can perform fast fault tolerance as an advanced memory protection feature, which enables a boot operation with full memory performance while monitoring for DRAM device failures.

FIG. 4 is an operational flow diagram illustrating an example of a process 400 for executing SMDIC techniques, according to some embodiments. For context, the example process of FIG. 4 can be used to verify the integrity of the data stored in each of the multiple persistent memory devices installed in a host (e.g., server), backup up after an unexpected loss of power. There is a potential that data backed-up in the NAND Flash and restored to the DRAM of a NVDIMM board, as shown in FIG. 3, may include uncorrectable memory errors that have also been restored (e.g., in the case of NVDIMM-N). Accordingly, one or more processors of the host can execute the disclosed SMDIC techniques to mitigate the potential of a system crash, due to any restored uncorrectable memory errors. With reference now to FIG. 4, process 400 is illustrated as a series of executable operations performed by processor 401, which can be the main processor of a host including persistent memory devices. Processor 401 executes the operations of process 400, thereby implementing the disclosed SMDIC techniques. At operation 405 a system boot operation can be initiated. Then, at operation 410, if the SMDIC option is enabled, then the process 400 proceeds to operation 420. Otherwise, if it is determined at operation 410 that the SMDIC is disabled, then the process 400 continues the system boot operation at operation 415 without verifying the integrity of the data in persistent memory. In some cases, operation 415 involves booting the system without performing the SMDIC techniques. Alternatively, if the SMDIC option is enabled at operation 410, then process 400 continues to operation 420. It should be understood that as used herein the term boot operation can include a previous boot, a runtime after a boot, or a startup operation for a computer system. In some cases, the SMDIC option is enabled to ensure that any persistent memory device, such as a NVDIMM board (shown in FIG. 2), that is made visible to the OS operates appropriately (e.g., no issues with the ability to read data, or has no bad data stored). As alluded to above, executing the remaining operations of the process 400 may increase system boot time, as a function of each installed persistent memory device. However, the “smart” aspects of the process 400 only execute the subsequent operations of the SMDIC techniques at a boot-up under certain conditions that may be predictive indicators of uncorrectable memory errors. This is an improvement over scanning persistent memory at each boot in the manner of conventional memory error detection mechanisms, by minimizing the amount of time data integrity checking adds to the system boot. Thus, SMDIC techniques reduce the tradeoff of between booting downtime and memory reliability.

At operation 420, the process 400 performs a check for a smart data integrity check condition. According to the embodiments, various conditions can be used to implement the check at operation 420. As previously described, detecting conditions that may predict a high potential of uncorrectable memory errors, or a non-recoverable memory events can improve the overall efficiency of the process 400. In an embodiment, operation 420 can determine that the data integrity of a persistent memory device should be checked in the case when the device is newly added to the system (e.g., added after a previous boot). There are potential risks associated with a new persistent memory device that has been installed (e.g., damaged due to lengthy transit), constituting a high probability for uncorrectable memory errors, and a smart data integrity check condition. For example, if a previously unseen identification number is associated with the current NVDIMM board, then a smart data integrity check condition may have been met at operation 420.

In another embodiment, operation 420 considers whether a time period has elapsed from the most recent memory fast training. Memory fast training is a feature that speeds up a memory initialization by restoring the previous memory training values when memory contents are left undisturbed, for example during warm resets. In some cases, upon determining that the memory training values are too old, that is a set time period since the last fast training that resulted in new memory training values (e.g., a backup and restore) has elapsed, then the system will perform a new training. At operation 420, old fast training values will also indicate a smart data integrity check condition should be initiated. As an example, operation 420 determines that the smart data integrity check condition has been meet if the training values are older than 90 days, for example. Subsequently, the process 400 moves to operation 425.

In yet another embodiment, operation 420 considers whether a time period has elapsed from the most recent full data integrity check. In some cases, an extended period of time passing without the system verifying the integrity of the stored data can signify a high potential for uncorrectable memory errors. As a result, if operation 420 determines that the system has gone longer than 90 days since performing a full data integrity check on each of the installed persistent memory devices, then the smart data integrity check condition has been met and the process proceeds to operation 425. The time period used to drive the smart data integrity check conditions in process 400 can be configurable, allowing some customization of the SMDIC techniques for an intended application (e.g., set by a customer). For example, a time period from a full data integrity check can be extended as far out as 365 days in an operational setting where data integrity may not be a great concern. Conversely, the time period can be set to a short time from a full data integrity check, such that an integrity check is triggered at every system boot. This shorter time period may be desirable in certain environments where memory is highly vulnerable, and there may be high recurrence of uncorrectable memory errors.

In yet another embodiment, operation 420 considers whether memory errors were detected during a previous boot operation. As an example, when errors are detected by the data integrity check process, the detected errors can be sent as power-on self-test (POST) messages and logged. Logs can include standard error correction codes (ECCs), which identify an error as either correctable or uncorrectable. If, at operation 420, it is determined that an ECC for an uncorrectable memory error is present in the logs generated by the previous boot, then the smart data integrity check condition has been met and the process proceeds to operation 425. The concept behind this condition is that encountering a memory error, particularly an uncorrectable memory error, in the most recent data integrity check it a strong predictive indicator. Thus, when it is determined that an uncorrectable memory error was encountered in a previous boot, the likelihood that an uncorrectable memory error has persisted and will remain present in memory at the time of the next data integrity check. For instance, a faulty memory device can frequently generate uncorrectable memory errors. In some cases, the condition is based on the most recent boot, or most recent data integrity check performed by the system. Additionally, the condition can be based on a window of recent previous boots or data integrity checks performed by the system. For instance, operation 420 can determine whether an uncorrectable memory error was logged within the last three boots of the system.

In some cases, operation 420 can consider correctable memory errors in the log from the previous boot. The underlying concept is that observing a large number of correctable memory errors (or even a steadily increasing number of correctable memory errors) may inject bad data from the persistent memory into the system during normal operations, which has a potential to compound the problem into an uncorrectable memory error, ultimately. Another consideration is the ability to recover the system from detected correctable memory errors. Identifying correctable memory errors allows the various recovery mechanisms of the advanced memory error detection techniques to correct for these errors. To this end, considering correctable memory errors at operation 420 may result in preventative countermeasures, correcting the memory errors that are correctable prior to them becoming uncorrectable. In this embodiment, operation 420 can determine whether the number of correctable memory errors is greater than a threshold. For example, if there are more than 100 correctable memory errors identified in the log from the previous boot at operation 420, then the smart data integrity check condition has been met. It should be appreciated that the threshold for correctable memory errors is configurable and can be adjusted to any value deemed appropriate. In addition, operation 420 may apply other criteria in observing correctable memory errors. The smart data integrity check condition can be meet in various scenarios involving correctable memory errors that may indicate a larger problem (or impact the prediction of correctable memory errors). The correctable memory error conditions can include but are not limited to: correctable memory errors detected within the same region of the persistent memory device; correctable memory errors located on the same DRAM chip; and correctable memory errors located in memory address that are related to each other (e.g., contiguous memory addresses, memory addresses relating to data of a function). Subsequently, the process 400 moves to operation 425.

In another embodiment, operation 420 considers logs that generate additional parsing features, such as an index into the logs that can be easily analyzed to determine changes in logged information. As an example, memory module error logs have an index value. Thus, a change in an index value indicates a change in the log, and potentially a newly identified error. At operation 420, the process 400 can compare the current memory module error log index value to a previously stored index value, to determine whether new entries have been added to the log. If the memory module error log index value is determined to be new (e.g., comparison indicates different values), the smart data integrity check condition is met, and the process 400 continues to operation 425.

In yet another embodiment, operation 420 considers configuration changes relating to persistent memory. Reconfiguring persistent memory may be a scenario where the probability of uncorrectable increases due to a number of factors. For example, the unpredictability surrounding a new configuration may degrade operation and lead to errors. Accordingly, at operation 420, detecting changes in the persistent memory configuration can trigger the smart data integrity check condition. In the case of a memory module having volatile and persistent regions, as mentioned above, the memory configuration can be adjusted as a ratio between volatile and persistent (e.g., percentage). Operation 420 can consider the memory module memory ratio, and if the value has changed (reconfiguring persistent memory), then the smart data integrity check condition is met. Thereafter, the process 400 moves to operation 425.

In yet another embodiment, operation 420 considers spare block consumption by the memory module. According to the disclosed embodiments, a spare block capacity is a feature relating to the scalability of persistent memory devices. For instance, the system can allocate spare blocks, or a spare media, in the case of a failure (e.g., dynamic failover). In the case where a percentage of remaining spare blocks has dropped more than expected with nominal operation, then the particular persistent memory device has been reallocating blocks in a manner that suggests degradation and a higher potential of memory errors. Generally, spare blocks or percentage of remaining spare blocks (or percentage of remaining life) can be an indication of wear and possible underlying uncorrectable errors. In this embodiment, at operation 420, a value indicative of spare block consumption, such as a percentage of available spare blocks for the persistent memory device, is considered. In a scenario where the percentage of available spare blocks is less than a threshold, then the smart data integrity check is triggered at operation 420. Then, the process proceeds to 425. It should be understood that the threshold value for spare block consumption can be weighted based on several factors, such as factory settings, lifespan (e.g., percentage of spare blocks consumed after five years may be expected to be higher than the percentage of spare blocks consumed after only a year), and the like. In some cases, at operation 420, the smart data integrity check condition is met each time the percentage of available spare blocks changes since the last boot. As an example, if the percentage of remaining spare blocks for a persistent memory device is detected to be 40%, at operation 420. Furthermore, the 40% remaining spare blocks is detected to be a drop from 50% remaining spare blocks identified at the previous boot, then the data integrity check condition is satisfied. Thereafter, the process 400 proceeds to operation 425. It should be understood that process 400 can implement an individual, all, of any combination of the aforementioned smart data integrity check conditions as discussed above. This embodiment, which leverages the monitoring of spare block consumption (e.g., as a trigger for SMDIC techniques) can be particularly advantageous in memory devices that are not equipped with related built-in error correction features.

In the event that the smart data integrity check condition is not satisfied by any of the aforementioned checks at operation 420, persistent memory is not scanned for data integrity. That is, the check at operation 420 can indicate that there is a low probability of detecting an uncorrectable memory error, and that the boot process will be optimized by not scanning persistent memory where the predicted integrity of the stored data is high. In this case, the process 400 returns to operation 415 continuing the system boot.

Next, at operation 425, the SMDIC is run, which involves scanning persistent memory for errors. The memory scanning performed at operation 425 can be implemented using various memory scanning techniques that are capable of parsing bits in multiple memory locations (e.g., memory addresses). For example, a read scan during POST can detect ECCs in memory locations within a safe environment (e.g., read scan is the only thread running, and the system need not crash before progressing to the next memory address). The SMDIC techniques also include aspects that improve the efficiency and speed of the scan during operation 425 (and other portions of the process 400). As alluded to above in the case of an NVDIMM-N implementation, a single NVDIMM can have 8 GB (or more) of DRAM. Scanning the larger memory capacity of a NVDIMM in process 400 is further increased, as multiple NVDIMMs can be installed on the same host. For instance, a host can provide 12 slots for NVDIMMs allowing 192 GB memory capacity. Consequently, reducing the amount of time required to scan each NVDIMM ultimately yields significant improvements in efficiency of the SMDIC processes for larger scale systems, and reduces its impact on overall system boot time.

In an embodiment, a multi-threading approach is used to improve efficiency of the persistent memory scan during process 400. Some existing memory error detection mechanisms are implement using single-threading, where a single and separate thread is run for every individual process. Employing a multi-threading approach generally enhances performance of processes. Moreover, the benefits of multi-threading can be greatly increased by the utilization of a multi-processor architecture, where the multiple threads can run concurrently on a separate processor. For example, multiple threads can run in parallel on the different processing cores of the disclosed server (shown in FIG. 1). As previously discussed, a single server can have several cores in its processor capabilities, allowing for a greatly increased utilization for multi-threading. During operation 425, a multi-threading approach can be employed for the created processes. For purposes of discussion, the process 400 can be implemented to spawn a thread: per CPU socket; per memory controller (shown in FIG. 1); per channel; per persistent memory device. In some cases, multiple threads are employed for a single persistent memory device. For instance, a process created at operation 425 can generate multiple threads for a single NVDIMM, which in concert with multiple CPUs of the host, can optimize processing utilization and significantly reduce the amount to time required to scan each NVDIMM.

An additional efficiency improvement aspect involves a System Management Interrupt (SMI) handler. In an embodiment, running the SMDIC process 400 includes disabling the SMI handler at operation 425. The SMI handler is an aspect of system firmware (e.g., BIOS) that enters a special-purpose operating mode in which all normal operations, including the OS, is suspended in the presence of certain hardware interrupts (e.g., power). By design, the SMI handler consumes a large amount of CPU processing time and resources, interrupting other coexisting processes. There is a potential in the presence of memory errors that the SMI handler may be triggered, and negatively impact running the data integrity checks of process 400. However, in disabling the SMI handler, the data integrity check is capable of processing all errors on its own and does not need the SMI handler's assistance. Disabling the SMI handler mitigates its associated processing slowdowns, thereby improving the overall efficiency of scanning persistent memory over existing memory error detection mechanisms where the SMI handler remains enabled. It should be understood that the SMI handler does not need to be disabled for the SMDIC techniques to operate (e.g., disabling the SMI handler enhances SMDIC execution when disabled). Accordingly, there can be embodiments in which the SMDIC techniques are executed while the SMI handler remains enabled.

Moreover, another efficiency improvement aspect involves leveraging specialized CPU instructions to implement the load/store routines used in memory scanning. In an embodiment, processes at operation 425 employ Advanced Vector Extensions (AVX) instructions. AVX instructions are designed to use large widths (in bits) of the register file which sets the parameters for how much data a set of instructions can operate upon at a time. Due to the large widths, AVX instructions have an accelerated execution over regular CPU instructions, by moving larger quantities of bits. For example, AVX instructions can transfer 64 bytes of data into a register (e.g., cache line sized) in a single instruction, as compared to regular CPU read/write instructions that move a 64-bit value. Thus, implementing the data integrity check at operation 420 using AVX instructions (e.g., AVX vmovnt) can increase the speed and performance of the process (e.g., eight times faster than regular CPU instructions). Although the efficiency improvement aspects are discussed in reference to operation 420, it should be appreciated that, any of the operations of SMDIC process 400 can implement each, all, or a combination of the aforementioned aspects.

Thereafter, the process 400 moves to operation 430 to determine whether one or more errors were detected as a result of scanning persistent memory. Upon the detection of errors in operation 425, the process 400 may generate notifications as a POST message and logged in the IML logs. Accordingly, in an embodiment, POST messages and/or logs can be used to determine whether one or more errors were detected. In the case where no errors were detected (e.g., no POST messages or logs) from scanning the persistent memory device, then the process can end at operation 415. Running the SMDIC process and detecting no errors can indicate that the integrity of the data in the persistent memory is verified, further ensuring that the persistent memory devices are operating appropriately before being made visible to the OS. Alternatively, if errors are detected, the process 400 proceeds to operation 435. As alluded to above, the SMDIC techniques are run as a host-based process, which allows the extensive processing capabilities of the host to be leveraged. As a result of the extended processing, operation 430 can include providing a full list of all uncorrectable memory errors and uncorrectable memory errors that are detected from the smart data integrity check. The full list of uncorrectable errors can also include all of the uncorrectable errors detected throughout the life of the system (e.g., historical log). This is an advancement from many existing memory error detection mechanisms that are limited to presenting a certain number of memory errors that may be encountered in memory, particularly in the case where a number of memory errors is detected.

Next, at operation 435, the process 400 can further determine whether the one or more detected errors are correctable memory errors or uncorrectable memory errors, in order to determine an appropriate response. In some cases, parsing ECCs in POST messages or logs can be used to identify uncorrectable and correctable memory errors. If a correctable memory error is detected, the process 400 moves to operation 440.

At operation 440, the process 400 can initiate one or various recovery mechanisms, as correctable memory errors are indeed correctable. As an example, operation 440 can involve presenting the detected correctable memory error to the OS for recovery. In some cases, the recovery includes demand scrubbing. Demand scrubbing can be generally described as writing corrected data back to the persistent memory device after the correctable memory error was detected on a read transaction. Additionally, recovery 440 can include patrol scrubbing. Patrol scrubbing can proactively repair the correctable memory errors. In some cases, the recovery includes single device data correction (SDDC), which can be used with other known data correction techniques to ensure continued memory operation in the event of a correctable memory error. It should be appreciated that any mechanism or approach that corrects any detected correctable memory error in a manner that recovers the persistent memory device and verifies the integrity of the data stored therein can be used at operation 440.

Referring back to operation 435, in the case where an uncorrectable memory error is detected the process 400 continues to operation 445 to perform advanced memory protection. An uncorrectable memory error can be associated with multiple bits that have been compromised that have been stored in one or more degraded memory locations. As alluded to above, many existing memory error detection mechanisms are not capable of recovering from an uncorrectable memory error and are restricted to merely detecting and logging and the presence of uncorrectable memory error in memory. In contrast, the SMDIC techniques disclosed include various advanced memory protection techniques to attempt recovery of the persistent memory device or reduce the impact of a detected uncorrectable memory error (e.g., prevent system crash). In some cases, operation 445 involves performing a persistent memory address range scrub. The persistent memory address range scrub can map out the address ranges affected by the detected uncorrectable memory error, making those address ranges unavailable to the OS (addresses are avoided during normal operations). As an example, memory addresses relating to an uncorrectable memory error on a particular DRAM can be removed from the memory map at operation 445. Furthermore, some data (e.g., data with verified integrity) from the mapped-out DRAM can be recovered, or otherwise move to another DRAM or similar memory media device. According to some embodiments, an address range scrub can involve writing a special pattern to the addresses having detected uncorrectable memory errors. Such special patterns are commonly referred to as poison patterns, and can indicate that “this address is bad, and it was seen before.” In this embodiment, when memory devices are capable of storing the special patterns successfully, the CPU already has awareness of the memory error during future reads (e.g., uncorrectable memory error has been previously handled, and does not need to be reported again). If the memory device cannot store the special patterns successfully, then future reads will continue to return uncorrectable errors, and multiple error messages may be generated.

In some cases, the entire persistent memory device is mapped out from access by the OS as a result of the memory address range scrub. For example, operation 445 can map out an entire NVDIMM, preventing the OS from use of that NVDIMM and potentially harming the system. This also provides the added benefit of isolating the failing NVDIMM, allowing replacement to be targeted to only the failing NVDIMM, as opposed to replacing all of the persistent memory devices installed in the system, due to an uncorrectable memory error. In another case, the persistent memory device is disabled on the next boot after the uncorrectable error has been detected. Additionally, operation 445 can present the detected uncorrectable errors to an OS to attempt recovery. In an optimized operation of SMDIC, the detected uncorrectable error addresses are presented to the OS, allowing the OS to map out the page of memory containing these error addresses.

In some embodiments, process 400 is performed iteratively, and can be initiated at various events that can be related to restoring data from persistent memory, such as boots, warm resets, cold resets, power-on, and the like. Furthermore, it should be understood that some of the operations of process 400 can be performed iteratively for each persistent memory device that may be present. That is, process 400 can include N iterations of the data integrity aspects that correspond to N number of persistent memory devices implemented in the system. As an example, referring back to FIG. 1, operation 420 to operation 445 shown in FIG. 4, can be performed respectively for each of the nine persistent memory devices 125 installed in the slots 120a. In FIG. 4, process 400 is shown to return to operation 425 after the completion of operation 445, or after the completion of operation 440, to illustrate iterations of the SMDIC techniques which continue processing for the remaining persistent memory devices.

Accordingly, the SMDIC system and techniques described herein provide various aspects that improve efficiency and optimization over traditional memory error detection mechanisms. Even further, the efficiency offered by SMDIC techniques provide a faster boot with less downtime, which helps alleviate the tradeoff between booting speed and persistent memory data integrity. Consequently, SMDIC techniques can increase the reliability of persistent memory devices, verifying the integrity of the data stored thereon prior to visibility to the OS and nominal operations (after booting). Moreover, the techniques disclosed provide advanced memory protection, which handles uncorrectable memory errors in a manner that prevents OS crashes and attempts to recovery to decrease downtime and repairs.

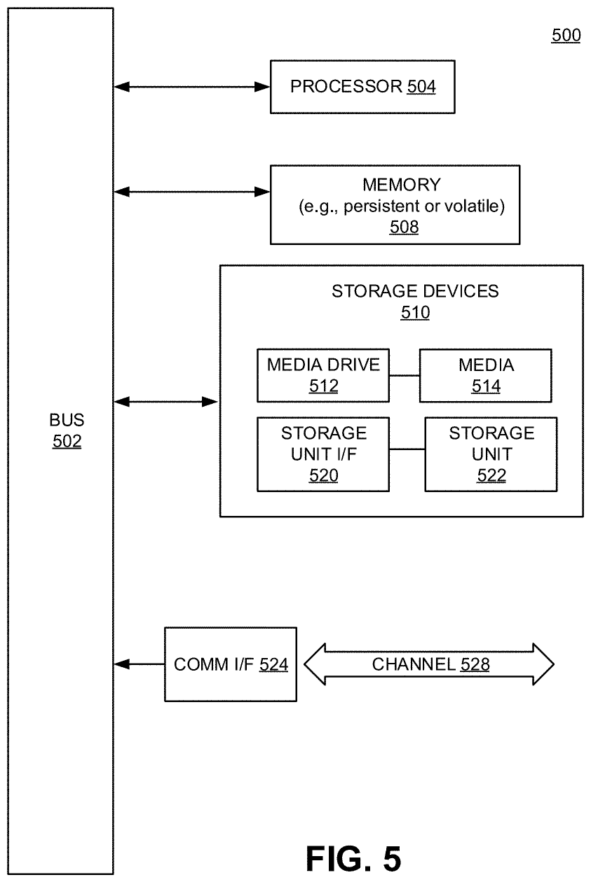

FIG. 5 depicts a block diagram of an example computer system 500 in which various SMDIC techniques of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 508, such as a random-access memory (RAM), cache and/or other dynamic storage devices, coupled to bus 502 for storing information and instructions to be executed by processor 504. Main memory 508 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes storage devices 510 such as a read only memory (ROM) or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 508. Such instructions may be read into main memory 508 from another storage medium, such as storage device 510. Execution of the sequences of instructions contained in main memory 508 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 508. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated service digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world-wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for verifying the data integrity of a persistent memory device, comprising:
initiating a boot of a system including the persistent memory device;
determining whether a data integrity check condition is satisfied;
upon determining that the data integrity check condition is satisfied, executing a data integrity check for the persistent memory device, wherein the data integrity check comprises scanning data stored in the persistent memory device.

2. The method of claim 1, further comprising:
upon determining that the data integrity check condition is satisfied, detecting whether at least one uncorrectable memory error is present within the persistent memory device based on the data integrity check, wherein the at least one uncorrectable memory error is associated with multiple bits stored in at least one degraded memory location; and
writing each detected uncorrectable memory error to a memory error log, wherein the memory error log is communicated to an Operating System (OS) associated with the system; and
upon determining that the data integrity check condition is not satisfied, completing the boot of the system without executing the data integrity check for the persistent memory device.

3. The method of claim 2, wherein detecting whether at least one uncorrectable memory error is present comprises performing an address range scrub of the at least one degraded memory location upon detecting that at least one uncorrectable memory error is present within the persistent memory.

4. The method of claim 1, wherein the data integrity check condition comprises:
determining whether an error log indicates that a previous uncorrectable memory error was detected during a previous boot of the system; and
determining that the data integrity check condition is satisfied when a previous uncorrectable memory error was detected in the previous boot.

5. The method of claim 1, wherein the data integrity check condition comprises:
determining whether the persistent memory device has been newly added to the system after a previous boot of the system; and
determining that the data integrity check condition is satisfied when the persistent memory device has been newly added to the system after the previous boot of the system.

6. The method of claim 1, wherein the data integrity check condition comprises:
determining whether a time period for performing memory training has been exceeded; and
determining that the data integrity check condition is satisfied when the time period for performing memory training has been exceeded.

7. The method of claim 1, wherein the data integrity check condition comprises:
determining whether a time period for performing a data integrity check for the persistent memory device has been exceeded; and
determining that the data integrity check condition is satisfied when the time period for performing a data integrity check for the persistent memory device has been exceeded.

8. The method of claim 1, wherein the data integrity check condition comprises:
determining whether an error log index value has changed since a previous boot of the system; and
determining that the data integrity check condition is satisfied when the error log index value has changed since a previous boot.

9. The method of claim 1, wherein the data integrity check condition comprises:
determining whether a configuration associated with the persistent memory device has changed since a previous boot of the system; and
determining that the data integrity check condition is satisfied when the configuration associated with the persistent memory device has changed since a previous boot of the system.

10. The method of claim 1, wherein the data integrity check condition comprises:
determining whether a percentage of spare blocks remaining associated with the persistent memory device is lower than a threshold; and
determining that the data integrity check condition is satisfied when the percentage of spare blocks remaining associated with the persistent memory device is less than the threshold.

11. The method of claim 1, wherein the data integrity check condition comprises:
determining whether an error log indicates that at least one correctable memory error was detected within the persistent memory device in a previous boot of the system;
if at least one correctable memory error was detected within the persistent memory device in the previous boot of the system, determining whether a number of correctable memory errors detected in the previous boot of the system is greater than a threshold;
determining that the data integrity check condition is satisfied when the number of correctable memory errors detected within the persistent memory device in the previous boot of the system is greater than the threshold.

12. The method of claim 1, wherein scanning data stored in the memory locations associated with the persistent memory device comprises executing one or more processes using multiple threads.

13. The method of claim 1, further comprising disabling a System Management Interrupt (SMI) handler prior to executing a data integrity check for the persistent memory device.

14. The method of claim 1, wherein scanning data stored in the memory locations associated with the persistent memory device comprises executing one or more Advanced Vector Extensions (AVX) instructions.

15. The method of claim 1, wherein executing a data integrity check for the persistent memory device verifies the integrity of data transferred to persistent components of the persistent memory device during a backup operation and maintains the memory error log over the lifetime of the system including a historical log of each detected correctable memory error and each detected uncorrectable memory error.

16. The method of claim 3, wherein performing the address range scrub of the at least one degraded memory location comprises removing the at least one degraded memory location from a memory map such that the at least one memory location is unavailable to an Operating System (OS) to prevent a system crash.

17. The method of claim 3, wherein performing the address range scrub of the at least one degraded memory location comprises presenting the at least one detected uncorrectable memory error to the OS associated with the system to attempt recovery.

18. A computer device comprising:
a processor;
a computer-readable medium having executable instructions stored thereon that, when executed by the processor, cause the processor to perform operations of:
executing a memory data integrity check that determines whether at least one uncorrectable error is present in a non-volatile memory, wherein the memory integrity check scans the non-volatile memory upon predicting a potential of memory errors present in the non-volatile memory.

19. The computer device of claim 18, wherein the executable instructions, when executed by the processor, further cause the processor to perform operations of: verifying the integrity of restored data upon predicting no potential of memory errors present in the non-volatile memory; and allows a boot to complete without scanning the non-volatile memory.

20. The computer device of claim 18, wherein the non-volatile memory comprise a non-volatile dual in-line memory module (NVDIMM).
